(19) United States
(12) Patent Application Publication
(10) Pub. No.: US 2005/0196549 A1
(43) Pub. Date: Sep. 8, 2005

(54) Microwave enhanced CVD method and apparatus

(75) Inventors: Takashi Inujima, Atsugi-shi (JP); Naoki Hirose, Atsugi-shi (JP); Mamoru Tashiro, Tokyo (JP); Shunpei Yamazaki, Tokyo (JP)

Correspondence Address: NIXON PEABODY, LLP, 401 9TH STREET, NW, SUITE 900, WASHINGTON, DC, 20004-2128, US

(73) Assignee: SEMICONDUCTOR ENERGY LABORATORY CO., LTD., Atsugi-shi (JP)

(21) Appl. No.: 11/102,651

(22) Filed: Apr. 11, 2005

Related U.S. Application Data
(62) Division of application No. 07/993,523, filed on Dec. 21, 1992.
Application No. 07/993,523 is a continuation of application No. 07/366,364, filed on Jun. 15, 1989, now abandoned.
Application No. 07/366,364 is a continuation of application No. 07/114,203, filed on Oct. 29, 1987, now abandoned.

(30) Foreign Application Priority Data
Nov. 10, 1986 (JP) SHO 61-266834
Jan. 5, 1987 (JP) SHO 62-0002981

(51) Int. Cl. H05H 1/02

(52) U.S. Cl. 427/569

(57) ABSTRACT

A new chemical vapor reaction system is described. Instead of ECR where electrons can move as independent particles without interaction, a mixed cyclotron resonance is a main exciting principal for chemical vapor reaction. In the new proposed resonance, the resonating space is comparatively large so that a material having a high melting point such as diamond can be deposited in the form of a thin film by this inovative method.

### BACKGROUND OF THE INVENTION

This invention relates to a microwave enhanced method and an apparatus therefor.

Recently, ECR CVD has attracted the interests of researchers as a new method of manufacturing thin films, particularly amorphous thin films. For example, Matsuo et al discloses one type of such a ECR CVD apparatus in U.S. Pat. No. 4,401,054. This recent technique utilizes microwaves to energize a reactive gas into a plasma state by virtue of a magnetic field which functions to pinch the plasma gas within the excitation space. With this configuration, the reactive gas can absorb the energy of the microwaves. A substrate to be coated is located distant from the excitation space (resonating space) for preventing the same from being spattered. The energized gas is showered on the substrate from the resonating space. In order to establish an electron cyclotron resonance, the pressure in a resonating space is kept at 1×10⁻³to 1×10⁻⁵ Torr at which electrons can be considered as independent particle and resonate with a microwave in an electron cyclotron resonance on a certain surface on which the magnetic field takes a particular strength required for ECR. The excited plasma is extrated from the resonating space, by means of a divergent magnetic field, to a deposition space which is located distant from the resonating space and in which is disposed a substrate to be coated.

In such a prior art method, it is very difficult to form a thin film of a polycrystalline or single-crystalline structure, so that currently available methods are almost limited to processes for manufacturing amourphous films. Also, high energy chemical vapor reaction is difficult to take place in accordance with such a prior art and therefore a diamond film or other films having high melting points, or uniform films on an even surface having depressions and caves can not be formed.

### SUMMARY OF THE INVENTION

It is therefore an object of the invention to provide a microwave enhanced CVD method and an apparatus therefor capable of forming a film, which can not be formed by prior art, such as a diamond film, or a film of a material having a high melting point.

According to one aspect of the invention, the surface of an object to be coated is located in a region of a resonating space in which electric field of a microwave takes its maxmum value. By this configuration, the deposition can be carried out while the deposited film is being partially sputtered, and therefore, e.g., a diamond film can be formed.

According to another aspect of the invention, a new CVD process has been culminated. The new process utilizes a mixed cyclotron resonance which was dirived firstly by the inventors. In the new type of exciting process, interaction of reactive gas itself must be taken into consideration as a non-negligible perturbation besides magnetic field and microwave, and therefore charged particles of a reactive gas can be absorbed in a relatively wide resonating space. For the mixed resonance, the pressure in a reaction chamber is elevated 10²-10⁵ times as high as that of prior art.

### BRIEF DESCRIPTION OF THE DRAWINGS

FIG. 1 is a cross section view showing a CVD apparatus in accordance with the present invention.

FIG. 2(A) is a graphical diagram showing the profile of the equipotential surfaces of magnetic field in cross section.

FIG. 2(B) is a graphical diagram showing the strength of electric field.

FIGS. 3(A) and 3(B) are graphical diagrams showing equi-potential surfaces in terms of magnetic field and electric field respectively.

FIG. 4 is a cross section view showing another embodiment in accordance with the present invention.

### DETAILED DESCRIPTION OF THE PREFERRED EMBODIMENTS

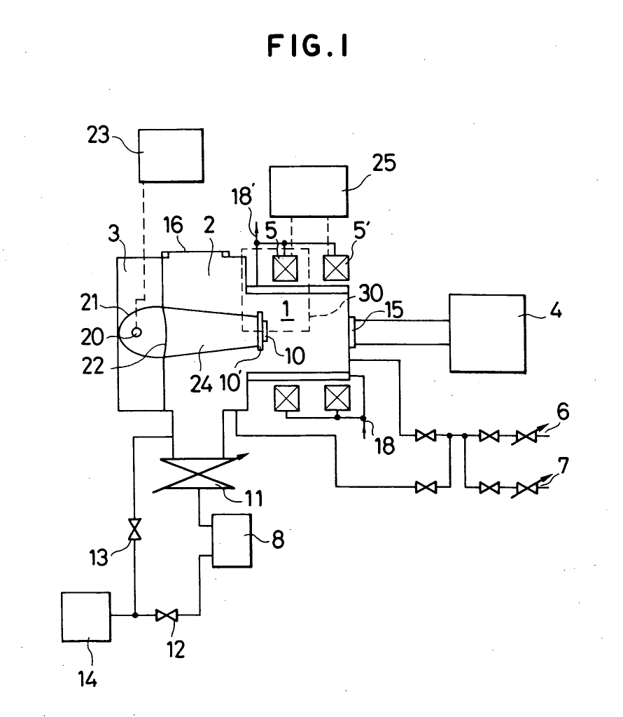

Referring to FIG. 1, a microwave enhanced plasma CVD apparatus in accordance with the present invention is illustrated. In the figure, the apparatus comprises a reaction chamber in which a plasma generating space 1 and an auxiliary space 2 are defined and can be held at an appropriate pressure, a microwave genarator 4, electro-magnets 5 and 5′ in the form of solenoids surrounding the space 1, a power supply 25 for supplying and electric power to the electro-magnets 5 and 5′, and a water cooling system 18. The plasma generating space 1 has a circular cross section. In the plasma generating space 1, a substrate holder 10′ made of a highly thermal conductive ceramic such as alminium nitride is provided on which a substrate 10 is mounted. The substrate holder 10′ is irradiated and heated to 150-1000° C. with an infrared light 24, which is emitted from an IR heater 20, reflected from an IR reflection parabola mirror 21 and focused on the back surface of the holder 10′ through a lens 22. A reference numeral 23 designates a power supply for the IR heater 20. Provided for evacuating the reaction chamber is an evacuating system comprising a turbo molecular pump 8 and a rotary pump 14 which are connected with the reaction chamber through pressure controlling valves 11, 12 and 13. The substrate temperature may reach a sufficient value only with the plasma gas generated in the reaction chamber. In the case, the heater can be dispensed with. Further, depending on the condition of the plasma, the substrate temperature might elevate too high to undergo a suitable reaction. In the case, cooling means has to be provided. The process with this apparatus is carried out as follow.

A substrate 10 is mounted on the substrate holder 10′ and heated by infrared light 24 to 500° C. Then, hydrogen gas is introduced from a gas introducing system 6 at 10 SCCM, and a microwave of 1 Kilo Gauss or stronger, e.g., 2.45 GHz is emitted from the microwave generator thorugh a microwave introduction window 15 to the plasma generating space 1 which is subjected to an magnetic field of about 2 K Gauss induced by the magnets 5 and 5′. The hydrogen is excited in a high density plasma state in the. space 1 by the energy of the microwave. The surface of the substrate is cleaned by high energy elecrons and hydrogen atoms. In addition to the introduction of the hydrogen gas, C₂H₂ and CH₄ are inputted through a introduction system 7, and excited by the energy of microwave at 1-800 Torr in the same manner as carried out with hydrogen explained in the foregoing description. As a result of a chemical vapor reaction, carbon is deposited in the form of a diamond film or an i-carbon (insulated carbon) film. The i-carbon is comprised of a mixture of diamond and amorphous carbon.

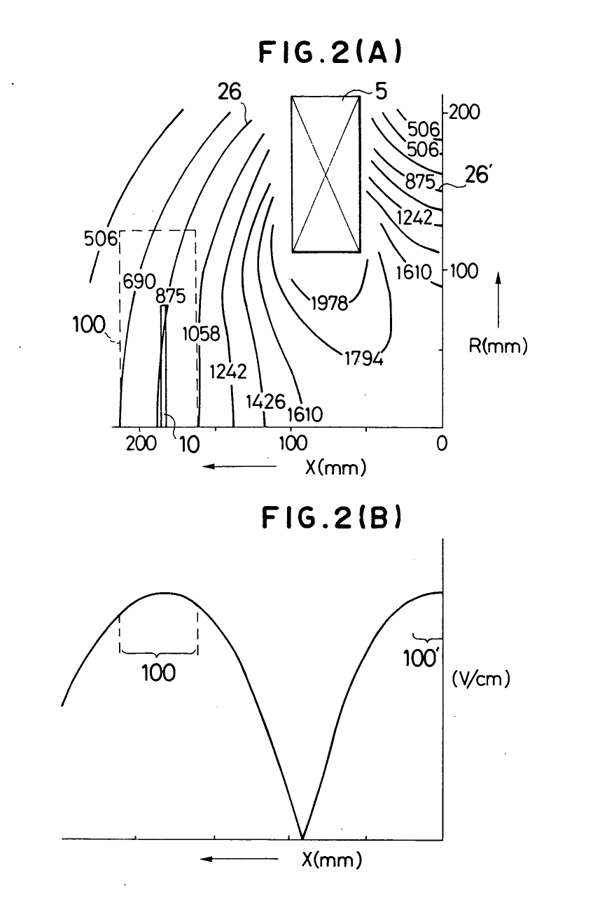

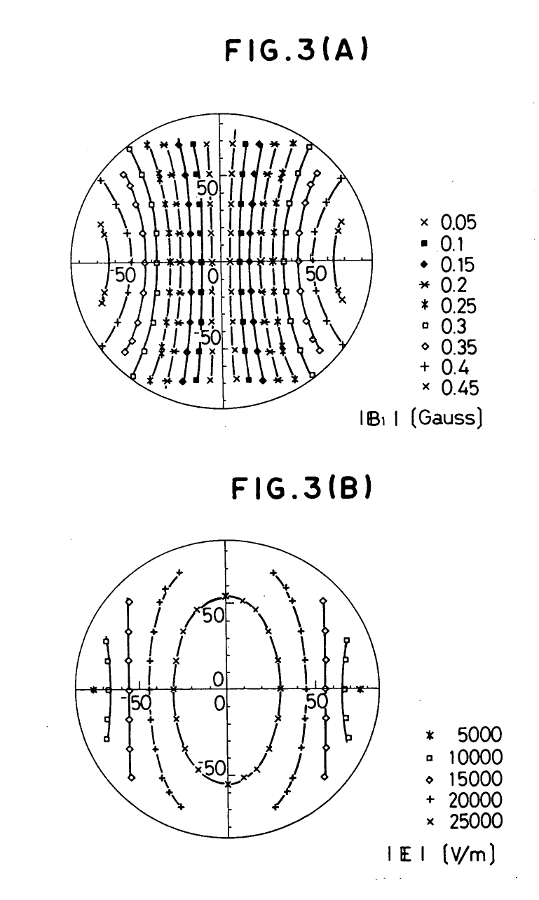

FIG. 2(A) is a graphical diagram showing the distribution of magnetic field on the region 30 in FIG. 1. Curves on the diagram are plotted along equipotential surfaces and marked with the strength values of the magnetic field induced by the magnet 5 having a power of 2000 Gauss. By adjusting the power of the magnets 5 and 5′, the strength of the magnetic field can be controlled so that the magnetic field becomes largely uniform over the surface to be coated which is located in the region 100 where the magnetic field (875±185 Gauss) and the electric field interact. In the diagram, a reference 26 designates the equi-potential surface of 875 Gauss at which ECR (electron cyclotron resonance) condition between the magnetic field and the frequency of the-microwave is sutisfied. Of course, in accordance with the present invention, ECR can not be establised due to the high pressure in the reaction chamber, 1-800 Torr, but instead a mixed cyclotron resonance (MCR) takes place in a broad region including the equipotential surface of the ECR condition. FIG. 2(B) is a graphical diagram corresponding to FIG. 2(A) and shows the strength of electric field of the microwave in the plasma generating space 1. The strength of the electric field takes its maximum value in the regions 100 and 100′. However, in the region 100′, it is difficult to heat the substrate 10′ without disturbing the propagation of the microwave. In other region a film is not uniformly deposited, but deposited the product in the form of a doughnut. It is for this reason that the substrate 10 is disposed in the reason 100. The plasma flows in the lateral direction. According to the experimental, a uniform film can be formed on a circular substrate having a diameter of less than 100 mm. Preferably, a film is formed in the chamber on a circular substrate having a diameter of less than 50 mm with a uniform thickness and a uniform quality. When a lager substrate is desired to be coated, the diameter of the space 1 can be double by making use of 1.225 GHz as the frequency of the microwave. FIGS. 3(A) and 3(B) are graphical diagrams showing the distributions of the magnetic field and the electric field on a cross section of the plasma generating space 1. The curves ploted in the circles of the figures correspond equipotential surfaces. As shown in FIG. 3(B), the electric field reaches its maxmum value at 25 KV/m.

The diffraction images of films formed in accordance with the present invention were obtained. As results, halo patterns were obserbed together with spots indicating the existence of diamond. The halo patterns gradually, which corresponds to an amorphous state, disappear as the substrate temperature elevates, and when the temperature rises beyond 650° C. the film became a diamond. At less than 150° C., i-carbon film could not be formed. For reference, a film formation process was performed in the same manner as in the above but without using a magnetic field. As a result, a graphite film was deposited.

In the same manner, polycrystalline silicon carbide films, and aluminium nitride films can be formed by making use of methyl silane, and alminium compound gas and ammonia gas respectively as a reactive gas. Further, other films having high melting points of tungsten, titanium, molybdenum or their silicon compounds can be formed in the similar manner.

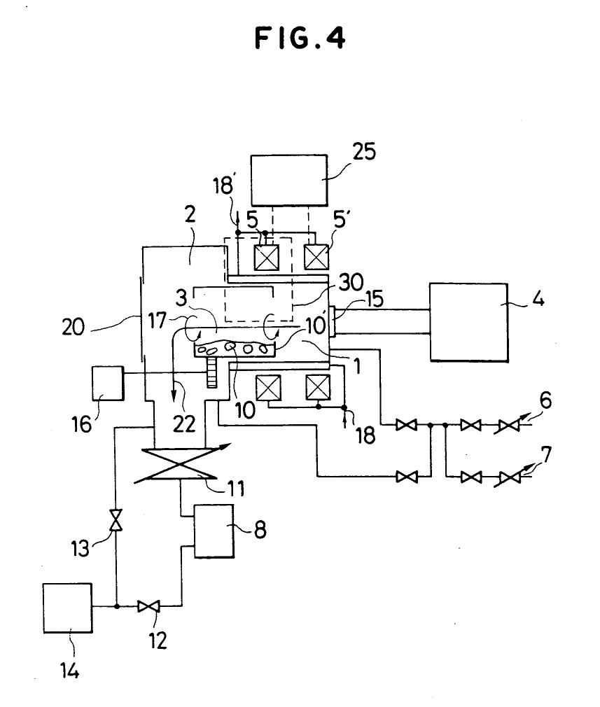

Referring to FIG. 4, another embodiment of the invention is illustrated. In the figure, the apparatus comprises a reaction chamber in which a plasma generating space 1 and an auxiliary space 2 are defined and can be held at an appropriate pressure, a microwave genarator 4, electro-magnets 5 and 5′ which are supplied with electric power from a power supply 25, and a water cooling system 18. The plasma generating space 1 has a circular cross section. In the plasma generating space 1, a hollow cylinder 10′ having inward-turned brims is rotatably supported in the space so that a microwave emitted from the microwave genarator 4 passes through the cylinder along its axis. The cylinder 10′ is made of a stainless steel or a quartz and turned by means of a motor 16 through a gear. Provided for evacuating the reaction chamber is a evacuating system comprising a turbo molecular pump 8 and a rotary pump 14 which are connected with the reaction chamber through pressure controlling valves 11, 12 and 13. The process with this appratus is carried out as follow.

Objects 10 to be coated, for example, metallic, plastic, ceramic parts (such as gears, screws, ornament jigs, or micro-particles for grinding) are put in the cylinder 10′ and turned at 0.1-10 rpm during process. The cylinder 10′, although the means is not illustrated in the figure, is shaken by micro-vibration of 1.00 Hz-10 KHz. By the turning and the vibration, the surfaces of the objects exposed to the surrounding are always switching during process. The reaction chamber is evacuated by the turbo molecular pump 8 and the rotary pump to 1×10⁻⁶ Torr or lower. Then, argon, helium or hydrogen as a non-productive gas is introduced to the reaction chamber from a gas introducing system 6 at 30 SCCM, and a microwave of 2.45 GHz is emitted from the microwave generator at 500 W through a microwave introduction window 15 to the plasma generating space 1 subjected to an magnetic field of about 2 K Gauss induced by the magnets 5 and 5′. The pressure of the non-productive gas is 1×10⁻⁴ Torr. A plasma is generated in the space 1 at a high density by the energy of the microwave. The surfaces of the objects 10 is cleaned by high energy elecrons and non-productive atoms. In addition to the introduction of non-productive gas, C₂H₂, C₂H₄ and/or CH₄ are introduced through a introduction system 7 at 1-800 Torr, preferably 3-30 Torr, e.g., 10 Torr, and excited by the energy of microwave in the same manner as carried out with the non-productive gas explained in the foregoing description. As a result of a mixed resonance, carbon is deposited in the form of a diamond film or an i-carbon film on the objects 10. In this embodiment, a heating means as illustrated in FIG. 1 may be used as in FIG. 1.

The distributions of magnetic field and electric field are same as FIG. 2(A), 2(B), 3(A) and 3(B) explained in conjunction with the preceding embodiment, and therefore redundant description is dispensed with.

The diffraction images of films formed in accordance with the present invention were obtained. As results, halo patterns were obserbed together with spots indicating the existence of diamond. The halo patterns gradually disappear as the substrate temperature elevates, and when the temperature rises beyond 650° C. the film became a diamond. At less than 150° C., i-carbon film could not be formed. For reference, a film formation process was performed in the same manner as in the above but without using a magnetic field. As a result, a graphite film was deposited.

In the same manner, polycrystalline silicon carbide films, and aluminium nitride films can be formed by making use of methyl-silane, and alminium compound gas and ammonia gas respectively as a reactive gas. Further, other films having high melting points of tungsten, titanium, molybdenum or their silicon compounds can be formed in the similar manner. For example, a BN or BP film could be formed in accordance with the present invention.

The pressure in the reaction chamber is chosen at that required for ECR condition, so that a preliminary plasma discharge takes place. While the discharge continues, the pressure is changed to 1 Torr to 3×10³ Torr where a mixed resonance takes place with a plasma of which particles have a mean free path of 0.05 mm to several milimeters, normally not more than 1 mm.

The process proposed by this invention is suitable for manufacturing superconductig ceramics including one or more rare earth-elements, one or more alkaline earth element (including Be and Mg) and Cu. In this case, a process gas is prepared by bubbling a solution of compounds of the elements with oxygen gas. For example, an organic solution (benzene, or alcohol solution) or a water solution of alkylenes or halides of Y(OC₂H₅)₃, Ba(OC₂H₅)₃ and CuBr₃ so that the stoichometric ratio among Y, Ba and Cu is 1:2:3. The stoichometric formula of the deposited product is YBa₂Cu₃O₆₋₈. In place of bubbling method, compounds of the elements can be inputted to the rection chamber by blowing the compounds in the form of fine powder with a highly pressurized oxgen gas, so called spraying method.

The invention should not limited to the above particular embodiments and many modifications and variations may cause to those skilled in the art. For example, instead of the hollow cylinder, any hollow member having a cross section of a polygon can be employ. Although the embodiments employ microwave energy alone under the exsitence of magnetic field, photon energy can be applied to the reactive gas excited by a mixed resonance, on a posistion depart from the mixed resonance.

1. A plasma chemical vapor reaction method capable of cyclotron resonance comprising the steps of:
inputting a reactive gas into a reaction chamber;
emitting microwaves into said reaction chamber at a frequency through a window in a direction of propagation;
establishing a magnetic field in said reaction chamber where the magnetic field has a strength sufficient to cause cyclotron resonance at a position in the reaction chamber;
exhausting the reaction chamber to establish a predetermined pressure in the chamber; and
holding a substrate located substantially at said position in the reaction chamber on a holder, wherein the strength of the magnetic field decreases along a line extending through said substrate in the direction of propagation of the microwaves.

2. A method as in claim 1 wherein the exhausting means is effected by at least a turbo-molecular pump.

3. A method as in claim 1 where said cyclotron resonance is mixed cyclotron resonance.

4. The plasma chemical vapor reaction method according to claim 1 wherein said substrate is arranged in said reaction chamber so that a major surface of said substrate is orthogonal to the direction of propagation of the microwaves.

5. The plasma chemical vapor reaction method according to claim 1 wherein said reaction chamber is exhausted through an outlet port provided in said reaction chamber, said outlet port being located on an opposite side of said substrate with respect to said window.

6. A plasma chemical vapor reaction method capable of cyclotron resonance comprising the steps of:
inputting a reactive gas into a reaction chamber;
emitting microwaves into said reaction chamber at a frequency in a direction of propagation;
establishing a standing wave of said microwaves therein, said standing wave having a maximum value at a position in the reaction chamber;
holding an object to be treated being located substantially at said position on a holder;
establishing a magnetic field in said reaction chamber where the magnetic field has a strength sufficient to cause cyclotron resonance in the reaction chamber; and
exhausting said reaction chamber to a predetermined pressure;
wherein the strength of the magnetic field decreases along a line extending through the substrate in the direction of propagation of the microwaves.

7. A method as in claim 6 wherein the exhausting is effected by at least a turbo-molecular pump.

8. A method as in claim 6 where said establishing the magnetic field causes said cyclotron resonance to occur approximately at the position where the object is held.

9. A method as in claim 6 where said cyclotron resonance is mixed cyclotron resonance.

10. The method of claim 1 or 6 further comprising controlling temperature of said substrate.

11. The method of claim 10 where said temperature is controlled by an infrared heater.

12. The method of claim 10 wherein said infrared heater is focused on said substrate from a back side of said holder.

13. The method of claim 12 wherein said reaction chamber includes a cylindrical wall.

14. The method of claim 1 or 6 wherein said method is for forming a coating on said substrate, said coating comprising a material selected from the group consisting of diamond, a mixture of diamond and amorphous carbon, boron nitride, aluminum nitride and boron phosphorous.

15. The method of claim 1 or 6 wherein the frequency of said microwave is 1.225 GHz or 2.45 GHz.

16. The plasma chemical vapor reaction method according to claim 6 wherein said substrate is arranged in said reaction chamber so that a major surface of said substrate is orthogonal to the direction of propagation of the microwaves.

17. A method of forming a film comprising the steps of:
inputting a reactive gas into a reaction chamber;
emitting microwaves into said reaction chamber at a frequency through a window in a direction of propagation;
establishing a magnetic field in said reaction chamber where the magnetic field has a strength sufficient to cause cyclotron resonance at a position in the reaction chamber;
exhausting the reaction chamber to establish a predetermined pressure in the chamber;
holding a substrate located substantially at said position in the reaction chamber on a holder, wherein the strength of the magnetic field decreases along a line extending through said substrate in the direction of propagation of the microwaves; and
forming a film over said substrate by using the reactive excited by the cyclotron resonance.

18. The method as in claim 17 wherein the exhausting step is effected by at least a turbo-molecular pump.

19. The method as in claim 17 wherein said cyclotron resonance is a mixed cyclotron resonance.

20. The method according to claim 17 wherein said substrate is arranged in said reaction chamber so that a major surface of said substrate is orthogonal to the direction of propagation of the microwaves.

21. The method according to claim 17 wherein said reaction chamber is exhausted through an outlet port provided in said reaction chamber, said outlet port being located on an opposite side of said substrate with respect to said window.

22. A method of forming a film comprising the steps of:
inputting a reactive gas into a reaction chamber;
emitting microwaves into said reaction chamber at a frequency in a direction of propagation;
establishing a standing wave of said microwaves therein, said standing wave having a maximum value at a position in the reaction chamber;
holding an object to be treated being located substantially at said position on a holder;
establishing a magnetic field in said reaction chamber where the magnetic field has a strength sufficient to cause cyclotron resonance in the reaction chamber;
exhausting said reaction chamber to a predetermined pressure; and
forming a film on said object by using the reactive gas excited by the cyclotron resonance,
wherein the strength of the magnetic field decreases along a line extending through the substrate in the direction of propagation of the microwaves.

23. The method as in claim 22 wherein the exhausting step is effected by at least a turbo-molecular pump.

24. The method as in claim 22 wherein said establishing a magnetic field step causes said cyclotron resonance to occur approximately at the position where the object is held.

25. The method as in claim 22 wherein said cyclotron resonance is a mixed cyclotron resonance.

26. The method of claim 17 or 22 wherein said film comprises a material selected from the group consisting of diamond, a mixture of diamond and amorphous carbon, and aluminum nitride.

27. The method of claim 17 or 22 further comprising controlling the temperature of said substrate or object.

28. The method of claim 27 wherein said temperature is controlled by an infrared heater.

29. The method of claim 28 wherein said infrared heater is focused on said substrate from a back side of said holder.

30. The method of claim 17 or 22 wherein the frequency of said microwave is 1.225 GHz or 2.45 GHz.

31. The method according to claim 22 wherein said substrate is arranged in said reaction chamber so that a major surface of said substrate is orthogonal to the direction of propagation of the microwaves.

32. The method according to any one of claims 17 and 22 wherein said film comprises carbon.

33. The method according to any one of claims 17 and 22 wherein said film comprises diamond.
